(19) United States
(12) Patent Application Publication
(10) Pub. No.: US 2008/0040282 A1
(43) Pub. Date: Feb. 14, 2008

(54) Content Use System

(76) Inventors: Masaya Yamamoto, Osaka (JP); Ryuichi Okamoto, Osaka (JP); Akio Higashi, Osaka (JP)

Correspondence Address: WENDEROTH, LIND & PONACK L.L.P., 2033 K. STREET, NW, SUITE 800, WASHINGTON, DC, 20006, US

(21) Appl. No.: 11/579,701

(22) PCT Filed: Apr. 26, 2005
(86) PCT No.: PCT/JP05/07890

§ 371 Date: Nov. 6, 2006

(30) Foreign Application Priority Data
May 10, 2004 (JP) 2004-140358

(51) Int. Cl. G06Q 10/00; G06F 17/30; H04L 9/00

(52) U.S. Cl. 705/52

(57) ABSTRACT

A content use system is provided which permits the use of content under appropriate use conditions while maintaining a high security level. A host (100) includes a secure data management unit (105) which securely manages secure data, a host communication processing unit (101) which transmits secure data managed by the secure data management unit (105) to a card (200), and a playback unit (104) which uses the content in the case where use of the content is assessed to be permitted by the card (200); the card (200) includes a license management unit (203) which holds use conditions for the content, a card communication processing unit (201) which acquires the secure data from the host (100), and a usability assessment unit (204) which assesses whether or not use of the content is permitted by the host (100) based on the secure data acquired by the card communication processing unit (201) and the use conditions held in the license management unit (203).

### TECHNICAL FIELD

The present invention relates to a content use system which uses digitally authored content according to a license.

### BACKGROUND ART

In the past, content use devices which receive a license and play back digitally authored content have been proposed (see for example, Patent Document 1).

These kinds of content use devices acquire encrypted content from a server through a communication channel, and when there is a license for the content, decrypt the content using the license and play back the content. In the license, use conditions for the content and a content key for decrypting the content are included. In the use conditions, a number of uses for the content and so on are included. In other words, in order to play back the content, the content use device distinguishes whether or not the use condition included in the license, that the number of uses for the content be greater than or equal to 1, is true, i.e. whether or not use of the content is permitted under the license. As a result, when the number of uses for the content is greater than or equal to 1, the content use device plays back the content using the content key.

Also proposed are content use systems which are configured in such a way that part of the functions of the above content use device are implemented in to a card.

The card includes functions for managing the license and for judging whether or not use of content is permitted under the license.

When the card is inserted into the content use device, the content use device queries the card about whether or not use of the content is permitted. The card, which has received the query, distinguishes whether or not use of the content is permitted based on the use conditions included in the license for the content, and when the card distinguishes that use of the content is permitted, the card transfers the content key to the content use device. The content use device decrypts the content using the content key received from the card, and plays back the content.
[Patent Document 1] Japanese Laid-Open Patent Application No. 2003-58660

### DISCLOSURE OF INVENTION

Problems that Invention is to Solve

However, there is the problem that for a card in a conventional content use system, the settings for the use conditions are restricted and the content use system cannot judge appropriately whether or riot use of the content is permitted

In order to judge whether or not use of the content is permitted, the card requires bases for judging whether or not use of the content is permitted in accordance with the use conditions. In other words, a present date/time is required as a judging basis when a use permitted period is set as a use condition, and a region in which the content is used is required as a judging basis when a use permitted region is set as a use condition. However, since the card operates by electricity provided from the content use device, it is difficult to include a clock, which needs a continuous power supply, in the card. Therefore, since it is difficult for the card to manage the present date/time, the card cannot judge whether or not use of the content is permitted based on a use permitted period. Also, even if a region in which the content is to be used is recorded onto the card, the card can easily be transported beyond the region, and thus recording the region onto the card is meaningless. Accordingly, the card cannot judge whether or not use of the content is permitted based on the use permitted region.

Therefore, the present invention has been conceived in consideration of the problems above, and has an object to provide a content use system which can use content under appropriate use conditions while maintaining a high security level.

Means to Solve the Problems

In order to accomplish the objects above, the content use system in the present invention includes a card and a host terminal and uses digitally authored content by mutual communication between the card and the host terminal, the host terminal includes: a secure data management unit which securely manages secure data used for assessing whether or not use of the content is permitted; a data transmission unit which transmits the secure data managed by the secure data management unit to the card; a use unit which uses the content in the case where use of the content has been assessed to be permitted by the card, and the card includes: a condition holding unit which holds a use condition for the content; a data acquisition unit which acquires the secure data from the host terminal, and an assessment unit which assesses whether or not use of the content is permitted in the host terminal based on the secure data acquired by the data acquisition unit and the use condition held in the condition holding unit. For example, the secure data management unit manages a present date/time obtained by time measurement, as the secure data, the condition holding unit holds a use condition which indicates a use permitted period, and the assessment unit assesses that use of the content is permitted when the date/time indicated by the secure data are within the use permitted period, which is a use condition, and assesses that use of the content is not permitted when the date/time indicated by the secure data is not within the use permitted period of the content. Or, the secure data management unit manages a usage region in which the content is used as the secure data, the condition holding unit holds the use condition which indicates permitted regions for the content, and the assessment unit assesses that use of the content is permitted when the usage region indicated by the secure data is among the permitted regions for the content, which is a use condition, and assesses that use of the content is not permitted when the usage region indicated in the secure data is not among the permitted regions.

With this, since the card holds the use conditions and assesses whether or not use of the content is permitted, a high security level can be maintained and since the host terminal manages the secure data and makes the card assess whether or not use of the content is permitted based on the secure data by sending the secure data to the card, it is possible to use a present date/time that cannot be managed by the card or a usage region that is meaningless when recorded to the card as secure data and as material for assessing whether or not use of the content is permitted, and as a result, the host terminal can play back the content under appropriate use conditions. In addition, since secure data is securely managed in the host terminal, the content use system can prevent the content from being used in an unauthorized way.

Also, the card further includes a secure data holding unit that securely holds card secure data, which is used to judge whether or not use of the content is permitted, and the assessment unit assesses whether or not use of the content is permitted based on the secure data, the card secure data and the use condition. For example, the card further includes a date/time holding unit which securely holds a date/time indicated by the secure data most recently acquired by the data acquisition unit, and the assessment unit assesses that use of the content is not permitted in the host terminal when a date/time indicated by the secure data acquired by said data acquisition unit is earlier than the date/time held by said date/time holding unit. Or the card further includes a region holding unit which securely holds region data that indicates a predetermined region, and the assessment unit assesses that use of the content is not permitted in the host terminal when the usage region indicated by the secure data acquired by the data acquisition unit does not match a region indicated by the region data.

With this, the security level can be further increased since it has been assessed whether or not use of the content is permitted, including card secure data.

Note that the present invention may be realized as a content use system method as above, or as a recording media which stores respective programs of the card and the host terminal included in the content use system.

### EFFECTS OF THE INVENTION

The content use system in the present invention performs the functional effect of using content under appropriate use conditions while maintaining a high security level.

### BRIEF DESCRIPTION OF DRAWINGS

FIG. 1 is a structural diagram which shows a configuration of a content use system in the first embodiment of the present invention;

FIG. 2 is a block diagram which shows the internal configurations of the host and the card in the first embodiment of the present invention;

FIG. 3 is a diagram which shows data items included in a license in the first embodiment of the present invention;

FIG. 4 is a sequence diagram which shows operations of the host and the card in the first embodiment of the present invention;

FIG. 5 is a block diagram which shows internal configurations of a card and a host for the content use system in a modification of the first embodiment of the present invention;

FIG. 6 is a flowchart which shows operations of the card in the modification of the first embodiment of the present invention;

FIG. 7 is a flowchart which shows operations of the card in the modification of the first embodiment of the present invention;

FIG. 8 is a block diagram which shows internal configurations of a host and a card in the second embodiment of the present invention;

FIG. 9 is a diagram which shows the data items included in the license which the license management unit manages in the second embodiment of the present invention;

FIG. 10 is a diagram which shows the data items included in subscription service identification data which the subscription service management unit manages in the second embodiment of the present invention;

FIG. 11 is a flowchart which shows operations of a usability assessment unit in the card in the second embodiment of the present invention;

FIG. 12 is a diagram which shows the use conditions according to the modification of the second embodiment of the present invention;

FIG. 13 is a block diagram which shows internal configurations of a host and a card in the third embodiment of the present invention;

FIG. 14 is a diagram which shows the data items included in the license which the license management unit manages in the third embodiment of the present invention;

FIG. 15 is a flowchart which shows operations of a usability assessment unit in the card in the third embodiment of the present invention;

FIG. 16 is a block diagram which shows an internal configuration of the card in the fourth embodiment of the present invention; and

FIG. 17 is a flowchart which shows operations of the usability assessment unit of the card in the third embodiment of the present invention.

### NUMERICAL REFERENCES

100 Host

101 Host communication processing unit

102 Host authentication management unit

103 Content storage unit

104 Playback unit

105 Secure data management unit

105a Clock unit

105b Region unit

200, 200a Card

201 Card communication processing unit

202 Card authentication management unit

203 License management unit

203a Use conditions

203b Content key

203L License

204, 204a Usability assessment unit

### BEST MODE FOR CARRYING OUT THE INVENTION

### First Embodiment

Hereinafter, the first embodiment of the present invention is described in detail with reference to diagrams.

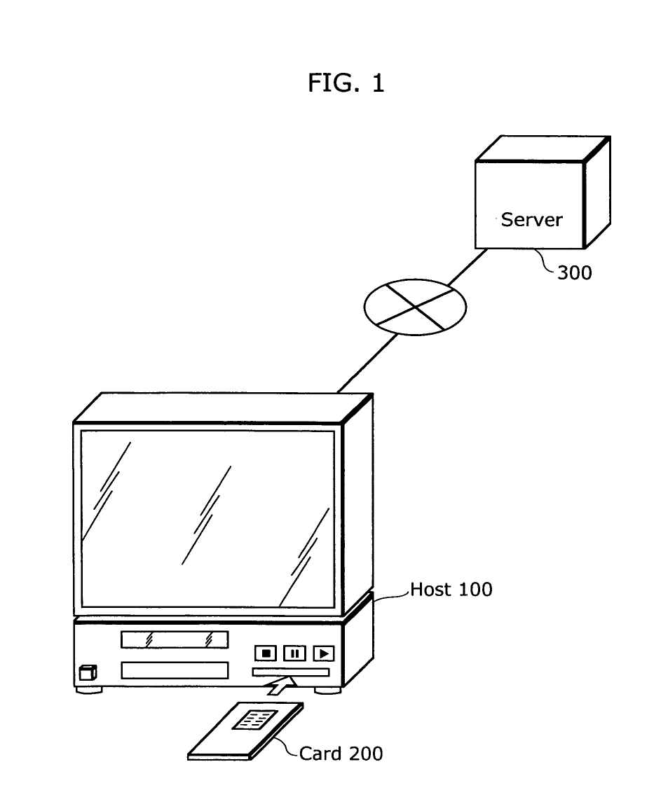

FIG. 1 is a structural diagram which shows a configuration of a content use system in the present embodiment.

This content use system permits the use of content under appropriate use conditions while maintaining a high security level and includes a host 100 and a card 200, which is inserted into the host 100.

The host 100 acquires encrypted content from the server 300 through a communication channel such as the Internet, decrypts and plays back the content.

The card 200 is, for instance, configured as an Integrated Circuit (IC) card to communicate with the host 100 by being inserted into the host 100. The card 200 holds a license for the content and assesses whether or not use of the content is permitted based on use conditions included in the license. When the host 100 assesses use of the content to be permitted, the card 200 transfers the content key to the host 100.

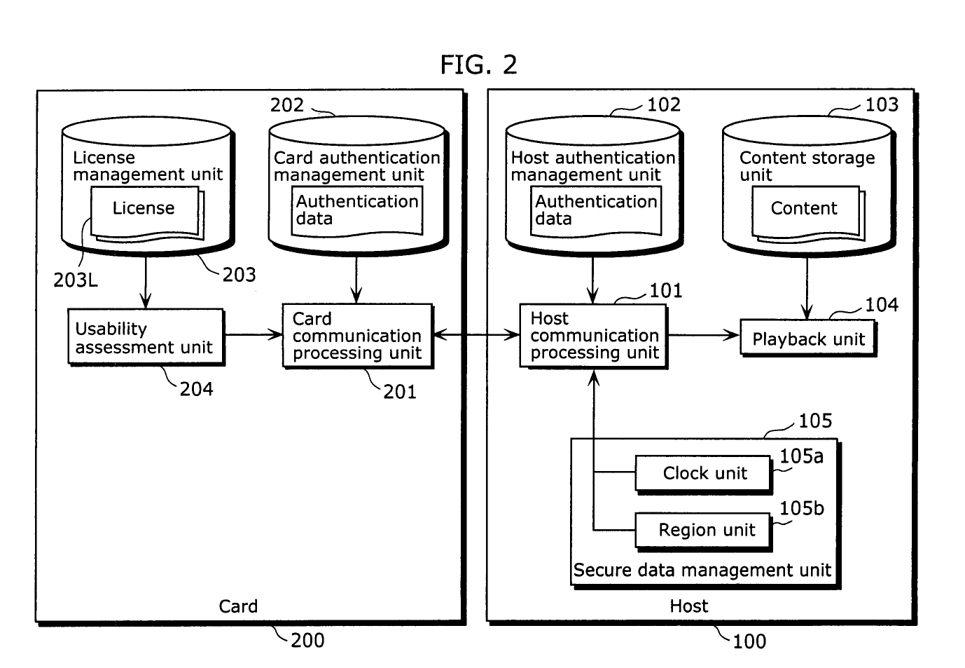

FIG. 2 is a block diagram which shows the internal configurations of the host 100 and the card 200.

The host 100 includes a host communication processing unit 101 which communicates with the card 200, a host authentication management unit 102 which holds authentication data including a secret key for the host 100, a public key certificate and a revocation list, a content storage unit 103 which stores encrypted content acquired from the server 300, a playback unit 104 which decrypts and plays back the content stored in the content storage unit 103, and a secure data management unit 105 which securely saves (manages) secure data that is utilized for assessing whether or not use of the content is permitted so that it will not be modified by a user. For instance, the secure data management unit 105 is tamper proofed by its hardware and/or software.

The card 200 includes a card communication processing unit 201 which communicates with the host 100, a card authentication management unit 202 which holds authentication data including a secret key, a public key certificate as well as a revocation list for the card 200, a license management unit 203 which stores and manages the above license 203L and a usability assessment unit 204 which assesses whether or not use of the content is permitted. The card 200 is tamper proofed by its hardware and/or software.

When communication is performed between the host communication processing unit 101 and the card communication processing unit 201, the host communication processing unit 101 transmits the public key certificate of the authentication data, held in the host authentication management unit 102, to the card communication processing unit 201, and the card communication processing unit 201 transmits the public key certificate of authentication data held in the card authentication management unit 202 to the host communication processing unit 101; thereby, the host communication processing unit 101 and the card communication processing unit 201 perform mutual authentication.

Here, upon authenticating each peer based on the peer's public key certificate, the host communication processing unit 101 and the card communication processing unit 201 confirm whether or not identification data for identifying the peer is registered in the revocation list. Identification data for identifying unauthorized devices is stored in the revocation list. Accordingly, the host communication processing unit 101 and the card communication processing unit 201 respectively recognize the peer as a legitimate peer if the peer's identification data is not registered in the revocation lists belonging to the host communication processing unit 101 or the card communication processing unit 201. On the other hand, when a peer's identification data is registered, the host communication processing unit 101 and the card communication processing unit 201 respectively prohibit communication with the peer equipment.

Further, the host communication processing unit 101 and the card communication processing unit 201 establish a secure authenticated channel (Secure Authenticated Channel, hereinafter, SAC) by exchanging session keys simultaneous to the mutual authentication above; the SAC being a channel in which a communication message is encrypted, transmitted and received using the session keys. In order to establish an SAC, for instance, a Secure Socket Layer (SSL) and a Transport Layer Security (TLS) are utilized.

In this way, in the present embodiment, the host 100 and the card 200 respectively authenticate peers and eliminate communication with unauthorized devices, and by establishing an SAC for data transmission and reception, maintain a high security level for mutual communication.

When the playback unit 104 plays back the content, the playback unit 104 requests a content key necessary for decoding the content from the host communication processing unit 101. Subsequently, the playback unit 104 acquires the content key from the host communication processing unit 101 and decrypts the content using the content key.

The secure data management unit 105 includes a clock unit 105a, which identifies the present date/time by time measurement, and a region unit 105b, which holds a region code that indicates a usage region for the content. In other words, the secure data management unit 105 respectively manages as secure data the present date/time identified by the clock unit 105a, and the region code held by the region unit 105b.

The host communication processing unit 101 accepts a request for the content key from the playback unit 104 and transmits a content ID for identifying the content as well as secure data managed by the secure data management unit 105 to the card communication processing unit 201. Next, upon acquiring the content key from the card communication processing unit 201 of the card 200, the host communication processing unit 101 outputs the content key to the playback unit 104.

The usability assessment unit 204 acquires the content ID and the secure data from the host 100 through the card communication processing unit 201, and searches for the license 203L, which corresponds to the acquired content ID, from among the licenses 203L managed by the license management unit 203. Subsequently, the usability assessment unit 204 assesses whether use of the content of the content ID is permitted by the host 100, based on the use conditions included in the license 203L i.e. the search result, and on the secure data acquired from the host 100. Upon assessing that use of the content is permitted, the usability assessment unit 204 transmits the content key included in the license 203L to the host communication processing unit 101 through the card communication processing unit 201.

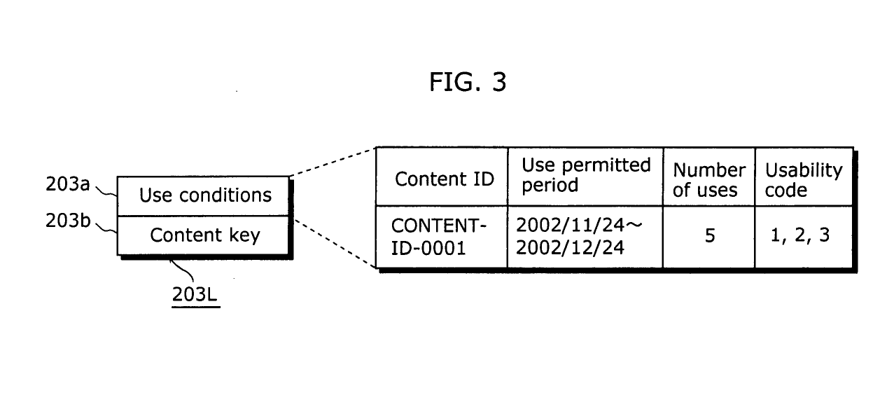

FIG. 3 is a diagram which shows data items included in the license 203L.

The license 203L includes use conditions 203a which indicate use conditions for the content, and a content key 203b required for decrypting the content.

The use conditions 203a include a content ID of a content to be used, a use permitted period for the content, a number of uses permitted for the content and a usability code which indicates a region in which use of the content is permitted.

For example, the use conditions 203a include a content ID “CONTENT-ID-0001”, a use permitted period “from Nov. 24, 2002 to Dec. 24, 2002”, 5 uses and usability codes “1,2,3”. In addition, the usability code 1 indicates, for example, the Japan region, the usability code 2 indicates, for example, the U.S.A. region, and the usability code 3 indicates, for example, the Britain region.

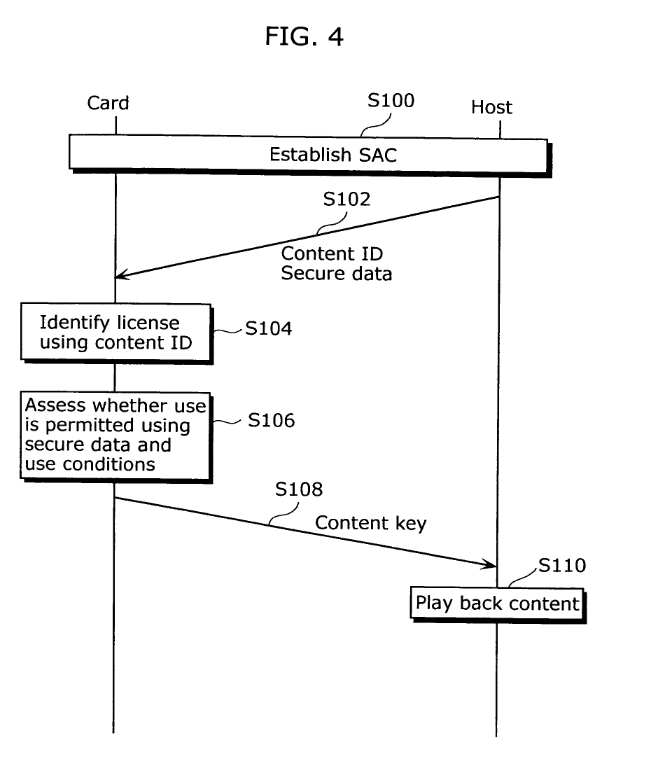

FIG. 4 is a sequence diagram which shows the operations of the host 100 and the card 200 in the present embodiment.

First, the host 100 and the card 200 establish the SAC after performing authentication respectively (Step S100).

Next, for example, upon accepting an instruction from the user prompting playback of the content, the host 100 queries the card 200 whether or not use of the content is permitted. In other words, the host 100 transmits the content ID of the content and the secure data to the card 200 (Step S102).

The card 200 identifies the license 203L corresponding to the content ID acquired from the host 100 from among the licenses 203L held by the license management unit 203 (Step S104).

For example, when the content ID transmitted from the host 100 is “CONTENT-ID-0001”, the card 200 identifies a license 203L which includes the use conditions 203a as shown in FIG. 3.

Further, the card 200 assesses whether the secure data acquired from the host 100 satisfies the use conditions 203a included in the license 203L identified in Step S104, in other words, whether or not the content of the content ID acquired is usable in the host 100 (Step S106).

For instance, in the case where the present date/time and the region code in the secure data are “Nov. 25, 2002 1:50 PM” and “1” respectively, and when the license 203L, which includes the use conditions 203a as in FIG. 3, is identified in Step S104, the card 200 assesses use of the content of the content ID “CONTENT-ID-0001” to be permitted in the host 100 since the present date/time and the region code in the secure data are included in the use permitted period and the usability code shown in the use conditions 203a, and since the number of uses for the content is 5. When the present date/time of the secure data is not included in the use permitted period, and when the region code in the secure data is not included in the usable area, the card 200 assesses use of the content as not permitted in the host 100.

Upon assessing use of the content to be permitted in Step S106, the card 200 transmits the content key 203b, which is included in the license 203L identified in Step S104, to the host 100 (Step S108), and renews the number of uses included in the use conditions 203a of the license 203L so that the number of uses is reduced by not more than 1 use. For example, when the use conditions 203a are as shown in FIG. 3, the usability assessment unit 204 for the card 200 renews the number of uses from 5 to 4.

The host 100, which acquires the content key 203b from the card 200, decrypts the content using the content key 203b and plays the content back (Step S110).

Then, if there is another content to be played back, the host 100 transmits the content ID and the secure data for identifying the content to the card 200 and repeatedly executes the operations from Step S102 to Step S110 above. In other words, the host 100 in the present embodiment transmits secure data every time the host 100 queries the card 200 about whether or not use of the content is permitted.

In the present embodiment, a high security level can be maintained by configuring the content use system with both the card 200, which holds the license 203L and is tamper proofed, and the host 100. Unlike a case where the host 100 is made to hold the secure data which must be managed securely for judging whether or not use of the content is permitted and thus the card 200 is made to hold the secure data, use of the content is permitted under appropriate use conditions, since use conditions can be set from a wide perspective.

(Modification 1)

Here, a first modification for the content use system in the present embodiment is described.

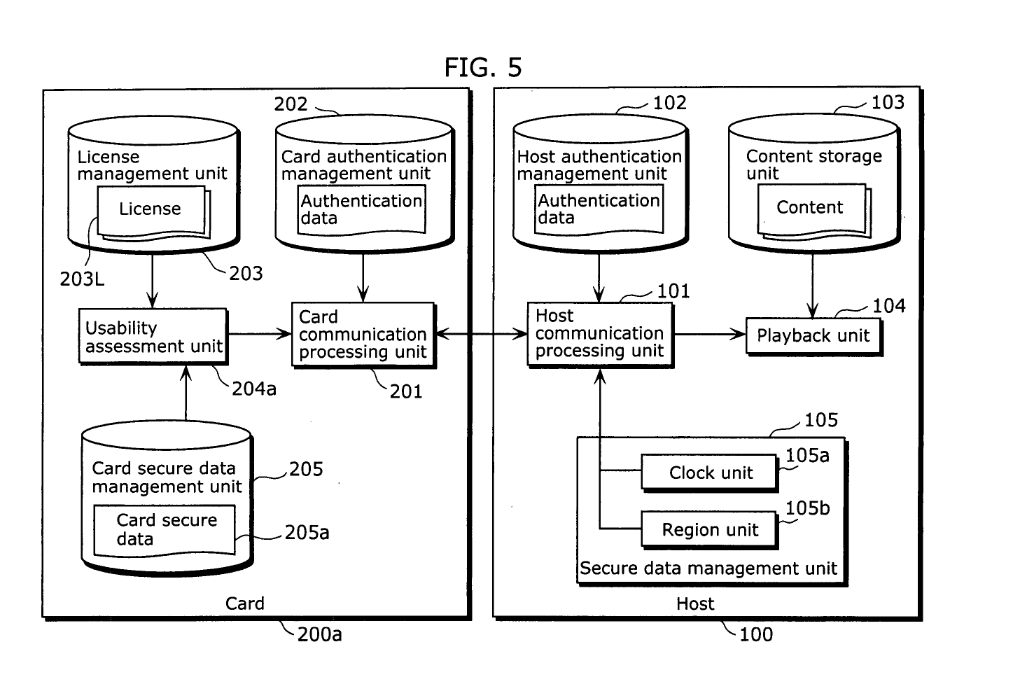

FIG. 5 is a block diagram which shows the internal configurations of a card 200a and a host 100 for the content use system in the present modification.

The content use system in the present modification is characterized in that the card 20a further improves the security level by including a card secure data management unit 205.

The card secure data management unit 205 saves the card secure data 205a securely so that it is not modified by the user. The card secure data 205a shows, for example, the present date/time of secure data most recently notified from the host 100. Hereinafter, the present date/time saved as the card secure data 205a by the card secure data management unit 205 is called the most recent date/time.

When a usability assessment unit 204a, according to the present modification, acquires the secure data from the host 100, the usability assessment unit 204a compares the present date/time and the most recent date/time included in the secure data. When the present date/time is later than the most recent date/time, the usability assessment unit 204a assesses whether or not use of the content is permitted based on, as above, the use conditions 203a of the license 203L and the secure data. On the other hand, when the present date/time is earlier than the most recent date/time, the usability assessment unit 204a considers the host 100 to be an unauthorized device, assesses that use of the content is not permitted, and adds the host ID which identifies the host 100 to a confirmation data revocation list that the card authentication management unit 202 holds. Here, the host ID is acquired by the card 200a when the SAC is established between the host 100 and the card 200a, or when mutual authentication is performed. Accordingly, when the host ID is registered in the revocation list, even when the card 200a tries to perform mutual authentication and establish an SAC with the host 100 corresponding to the host ID afterward, the host 100 of the host ID is considered unauthorized since the host ID is registered on the revocation list, and communication with the host 100 is prohibited. Note that, above, the usability assessment unit 204a considers the host 100 to be an unauthorized device when the present date/time is earlier than the most recent date/time, however when the present date/time is earlier than the most recent date/time by more than a predetermined time, the host 100 may be considered an unauthorized device. For example, the predetermined time is a few minutes. By assuming the present date/time to be earlier than the predetermined time, the card 200a is unaffected by fine tuning even when the present date/time is fine tuned to a correct date/time, and can clearly prohibit communication with unauthorized devices.

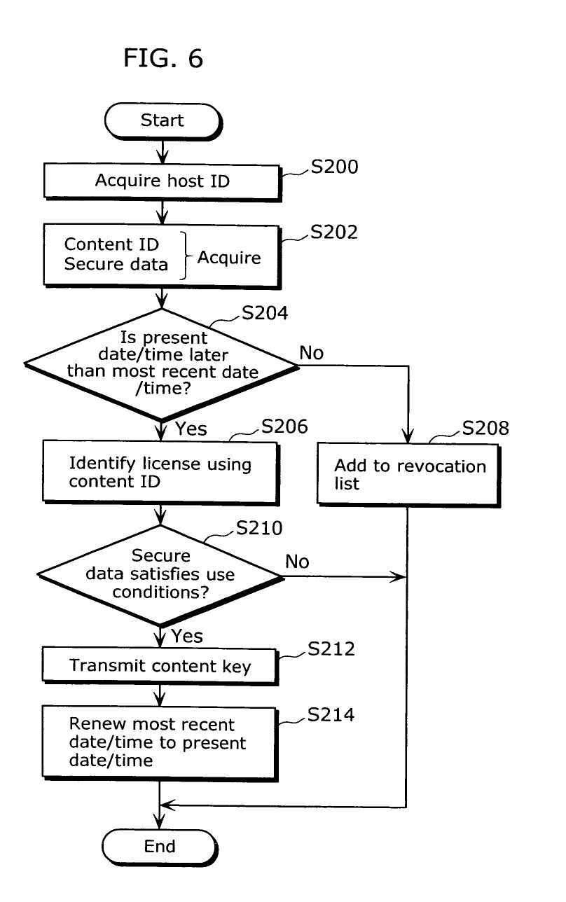

FIG. 6 is a flowchart which shows the operations of the card 200a in the present modification.

When the card 200a performs mutual authentication with, for example, the host 100, the card 200a acquires the host ID which identifies the host 100 from the host 100 (Step S200). Subsequently, the card 200a acquires the content ID and the secure data from the host 100 (Step S202) and distinguishes whether or not the present date/time included in the secure data is later than the most recent time saved in the card secure data management unit 205 (Step S204).

Here, when the card 200a distinguishes that the present date/time is later than the most recent date/time (Yes in Step S204), the card 200a identifies the license 203L using the acquired content ID (Step S206). On the other hand, when the present time is distinguished to be earlier than the most recent time (No in Step S204), the card 200a assesses that use of the content is not permitted by the host 100 which transmitted the secure data, and the card 200a considers the host 100 to be an unauthorized device, adding the host ID acquired in Step S200 to the revocation list of the card authentication management unit 202 (Step S208).

The card 200a, which identified the license 203L in Step S206, assesses whether or not the present date/time, the region code, and the number of uses (for example, one use) of the secure data satisfy the use conditions 203a (Step S210).

Here, when the card 200a assesses that the secure data and the number of uses satisfy the use conditions 203a (Yes in Step 210), the card 200a transmits the content key 203b to the host 100 (Step S212), and renews the most recent date/time saved in the card secure data management unit 205 to the present date/time of the secure data acquired in Step S202 (Step S214). At this point, the card 200a renews the number of uses in the use conditions 203a such that the number of uses is reduced by only one. On the other hand, upon assessing that the secure data and the number of uses satisfy the use conditions 203a (No in Step S210), the card 200a finishes processing without transmitting the content key 203b to the host 100.

In this modification, the security level can be further improved since the card 200a securely manages the present date/time of the most recently communicated secure data from the host 100 as the most recent date/time, and since the card 200a rejects the host 100 which communicates a present date/time earlier than the most recent date/time as secure data.

(Modification 2)

Here, the content use system in the present embodiment is described for a second modification.

In the content use system in the present modification and as in the first modification, the security level of the card 200a is further improved by including the card secure data management unit 205, however the card secure data 205a saved in the card secure data management unit 205, according to the present modification, differs from that of the first modification in that it is configured as a card region code which indicates a content usage region.

Upon acquiring the secure data from the host 100, the usability assessment unit 204a compares the region code included in the secure data and the card region code. When the region code and the card region code match, the usability assessment unit 204a assesses whether or not use of the content is permitted based on the use conditions 203a in the license 203L and the secure data as above, and when the region code and the card region code do not match, the usability assessment unit 204a prohibits transmission of the content key 203b to the host 100.

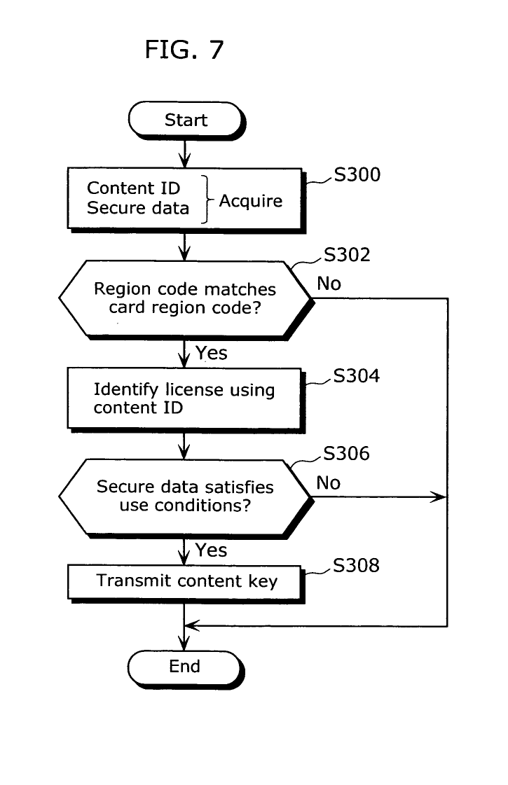

FIG. 7 is a flowchart which shows the operations of the card 200a in the present modification.

The card 200a first acquires a content ID and secure data from the host 100 (Step S300) and distinguishes whether or not the region code included in the secure data matches the card region code saved in the card secure data management unit 205 (Step S302).

Here, upon distinguishing that the region code and the card region code match (Yes in Step S302), the card 200a identifies the license 203L using the content ID (Step S304). However, when the card 200a distinguishes that the region code and the card region code do not match (No in Step S302), the card 200a assesses that use of the content is not permitted by the host 100 which transferred the secure data, and the card 200a finishes processing without transmitting the content key 203b to the host 100.

The card 200a, which identified the license 203L in Step S304, assesses whether or not the present date/time, region code and number of uses in the secure data satisfy the use conditions 203a.

Here, upon assessing that the secure data and the number of uses satisfy the use conditions 203a (Yes in Step S306), the card 200a transmits the content key 203b to the host 100 (Step S308). At this point, the card 200a renews the number of uses in the use conditions 203a so that the number of uses decreases by only one. Whereas, upon assessing that the secure data and the number of uses satisfy the use conditions 203a (No in Step S306), the card 200a finishes processing without transmitting the content key 203b to the host 100.

In this way, the security level can be further improved in the present modification, since the card 200a also assesses whether or not use of the content is permitted in consideration of the card region code.

### Second Embodiment

The content use system in the present embodiment can utilize content under appropriate use conditions while maintaining a high level of security, in the same way as the first embodiment, and includes a host and a card inserted into the host.

Here, the content use system in the present embodiment has the characteristic of selecting data which is used for assessing whether or not use of the content is permitted from secure data and non-secure data which can be modified by a user, according to the type, value, quality and so on of services, content and so on subscribed to by the user, as data used for assessing whether or not use of the content is permitted.

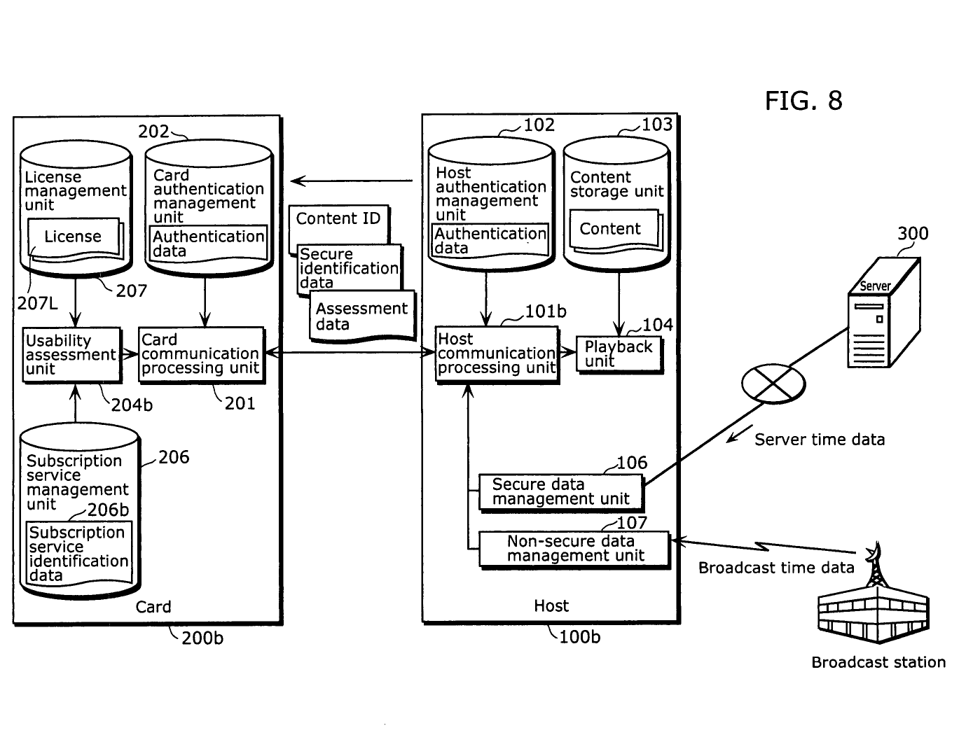

FIG. 8 is a block diagram which shows the internal configurations of a host and a card in the present embodiment.

The host 100b includes a host communication processing unit 101b, a host authentication management unit 102, a content storage unit 103, a playback unit 104, a secure data management unit 106 and a non-secure data management unit 107.

The card 200b includes a card communication processing unit 201, a card authentication management unit 202, a license management unit 207, a usability assessment unit 204b and a subscription service management unit 206. The card 200b is tamper proofed by its hardware.

Note that those elements among the constituent elements above in the present embodiment which are the same as the first embodiment are shown with the same numbering as the constituent elements in the first embodiment, and a detailed explanation is not repeated.

The secure data management unit 106 securely saves the secure data used for assessing whether or not use of the content is permitted so that the secure data cannot be modified by the user, in the same way as the secure data management unit 105 in the first embodiment. For example, the secure data management unit 106 is tamper proofed by its hardware and software. Here, the secure data management unit 106 in the present embodiment specifies the present date/time by time measurement and manages the present date/time identified as secure data. Also, the secure data management unit 106 acquires server time data, which indicates the present date/time, by communicating with the server 300, and amends the present date/time of the secure data managed by the secure data management unit 106 based on the server time data acquired.

The non-secure data management unit 107 saves the non-secure data used for assessing whether or not use of the content is permitted. Here, the non-secure data management unit 107 in the present embodiment identifies the present date/time by time measurement and manages the present date/time identified as the non-secure data. Also, the non-secure data management unit 107 acquires broadcast time data, which indicates the present date/time, from a broadcasting station which transmits content and so on by digital broadcast waves. The non-secure data management unit 107 then amends the present date/time in the non-secure data, which the non-secure data management unit 107 manages, based on the acquired broadcast time data. Note that the broadcast time data is a schedule which displays time in a broadcast clock such as a Time Offset Table (TOT) and a Date/time Table (TDT).

Hereinafter, the secure data managed by the secure data management unit 106 and the non-secure data managed by the non-secure data management unit 107 are generically called assessment data.

Upon accepting a request for a content key from the playback unit 104, the host communication processing unit 101b transmits to the card communication processing unit 201 the content ID for identifying content, the assessment data managed by the secure data management unit 106 or the non-secure data management unit 107, and secure identification data which identifies whether the assessment data is secure data or non-secure data. For example, when the host communication processing unit 101b in the present embodiment cannot acquire secure data due to communication difficulties, or when the host communication processing unit 101b assesses the reliability of the secure data to be low, i.e. in cases where, for example, the host communication processing unit 101b assesses that the present date/time indicated by the secure data has not been amended within the predetermined period, and transmits non-secure data as the assessment data, instead of secure data.

More specifically, among the functions of the host communication processing unit 101b, the function for attaching a content ID and transmitting secure data, non-secure data and secure identification data differs from the function of the host communication unit 101 in the first embodiment of transmitting secure data only; other functions are the same as the host communication device 101 in the first embodiment.

The license management unit 207 stores and manages plural licenses 207L which indicate service modes of the content.

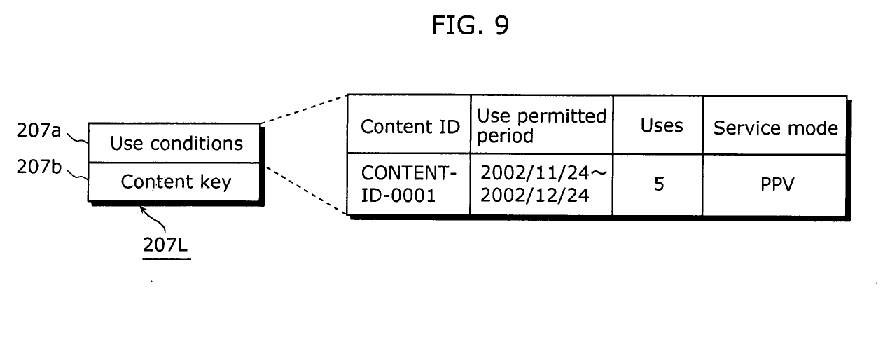

FIG. 9 is a diagram which shows data items included in the license 207L which the license management unit 207 manages.

The license 207L includes use conditions 207a which indicate the conditions for whether or not use of the content is permitted, and a content key 207b required for decrypting the content.

The use conditions 207a include a content ID for content to be used, a use permitted period for the content, a number of uses for the content and the service mode of the content. For instance, the use conditions 207a include the content ID “CONTENT-ID-0001”, the use permitted period “from Nov. 24, 2002 to Dec. 24, 2002”, 5 uses and the service mode “PPV”. Note that “PPV” means “Pay-per-view”, and when content corresponding to the license 207L is downloaded through a network, PPV means that the user will be charged according to the number of times downloaded and the number of times viewed.

The subscription service management unit 206 stores and manages subscription service identification data which indicates the type of service subscribed to by the user (subscription service).

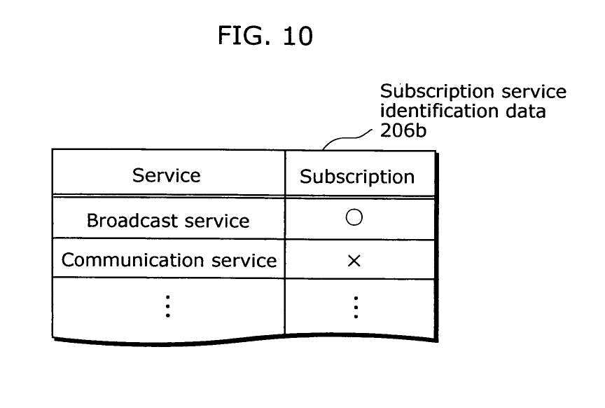

FIG. 10 is a diagram which shows data items included in subscription service identification data 206b, which the subscription service management unit 206 manages.

The subscription service identification data 206b includes titles of a variety of services and an identifier which indicates whether or not the user subscribes to each service.

For example, the subscription service identification data 206b includes “broadcast service”, “communication service” and so on as service titles, an identifier “O” which indicates that the user subscribes to the broadcast service, and an identifier “X” which indicates that the user is not subscribed to the communication service. Here, “broadcast service” indicates a service which provides content and a license from a broadcaster by digital broadcast wave, and “communication service” indicates a service which provides content and a license from a content provider server through the Internet.

Note that here, the present invention has been described for a case where the subscription service identification data 206b indicates only that the user is subscribed or unsubscribed to a service, however the service identification data 206b may be made to display further detailed service items such as PPV and month-to-month (subscription).

Upon acquiring a content ID, assessment data and secure identification data from the host 100b through the card communication processing unit 201, the usability assessment unit 204b identifies the license 207L, which corresponds to the content ID, from among plural licenses 207L managed by the license management unit 207. Subsequently, the usability assessment unit 204b assesses whether or not the content of the content ID can be used by the host 100b, based on the use conditions 207a included in the license 207L identified, assessment data acquired from the host 100b and secure identification data. Upon assessing that use of the content is permitted, the usability assessment unit 204b transmits the content key 207b included in the license 207L to the communication processing unit 101b through the card communication processing unit 201.

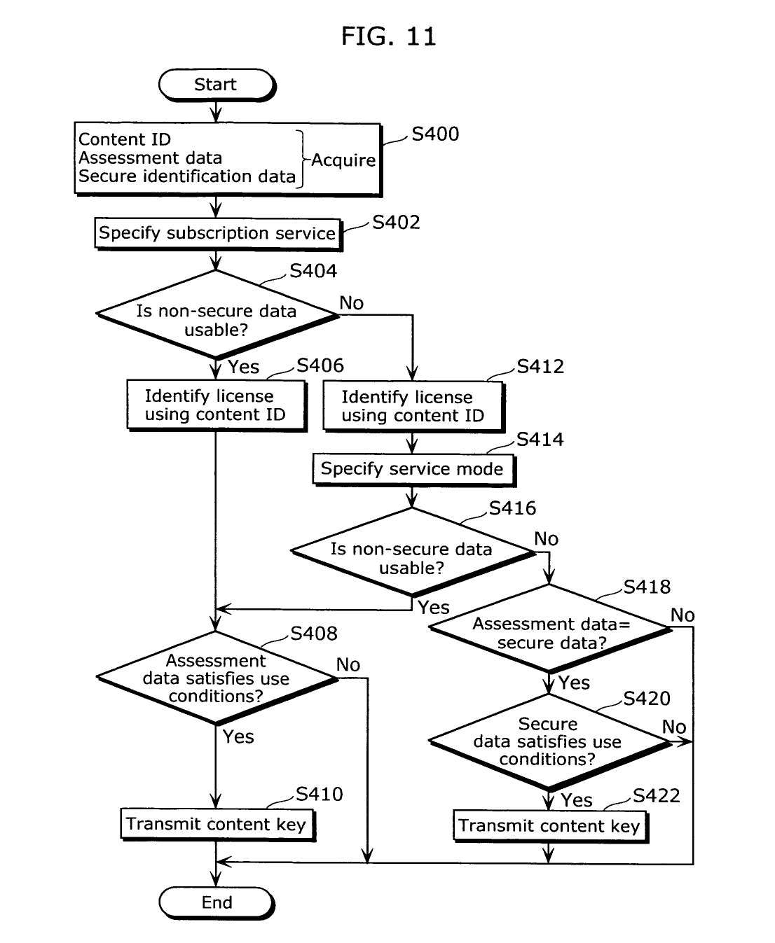

FIG. 11 is a flowchart which shows the operations of the usability assessment unit 204b in the card 200b in the present embodiment of the present invention.

First, the usability assessment unit 204b acquires the content ID, assessment data and secure identification data from the host 100b through the card communication processing unit 201 (Step S400). Next, the usability assessment unit 204b identifies the user's subscription services based on the subscription service identification data 206b of the subscription service management unit 206 (Step S402).

Here, the usability assessment unit 204b judges whether or not non-secure data can be used in assessing whether or not use of the content is permitted based on the subscription service identified in Step S402 (Step S404). For example, when “user is subscribed only to broadcast services” is indicated by the subscription service identification data 206b, the usability assessment unit 204b judges the non-secure data to be usable since secure data cannot be acquired through communication, and when “user is subscribed to communication service” is indicated by the subscription service identification data 206b, the usability assessment unit 204b judges the non-secure data to be unusable, since secure data can be acquired through communication.

When non-secure data is judged to be usable in Step S404 (Yes in Step S404), the usability assessment unit 204b identifies the license 207L from among the licenses 207L managed by the license management unit 207, and which corresponds to the content ID acquired in Step S400 (Step S406).

Next, the usability assessment unit 204b assesses whether or not the present date/time and the number of uses in the assessment data satisfy the use conditions 207a, regardless of whether or not the assessment data acquired in Step S400 is secure data (Step S408).

Here, upon assessing that the present date/time and the number of uses in the assessment data satisfy the use conditions 207a (Yes in Step S408), the usability assessment unit 204b transmits the content key 207b to the host 100b (Step S410). Whereas upon assessing that the present date/time and the number of uses in the assessment data do not satisfy the use conditions 207a (No in Step S408), the usability assessment unit 204b finishes processing without transmitting the content key 207b to the host 100b.

Also, when the non-secure data is judged to be unusable in Step S404 (No in Step S404), as above, the usability assessment unit 204b identifies the license 207L which corresponds to the content ID acquired in Step S400 (Step S412). Further, the usability assessment unit 204b identifies the service mode which the use conditions 207a, identified in Step S412, indicate (Step S414).

Subsequently, the usability assessment unit 204b judges whether or not the non-secure data is usable for assessing whether or not use of the content is permitted based on the identified service mode (Step S416). For example, when “PPV” is indicated in the use conditions 207a as the service mode, the usability assessment unit 204b judges that the non-secure data can be used, considering that “PPV” indicates high-value content. Also when, for example, “month-to-month” is indicated as the service mode in the use conditions 207a, the usability assessment unit 204b judges that the non-secure data is usable. Here, “month-to-month” indicates that in order to view the content corresponding to the license, a viewing period contract on a monthly basis is needed. Further, for example, when “SD video quality” is indicated as the service mode in the use conditions 207a, the usability assessment unit 204b judges that the non-secure data is usable, and when “HD picture quality” is indicated as the service mode in the use conditions 207a, the usability assessment unit 204b judges that the non-secure data is unusable. Note that “SD picture quality” indicates that the content which corresponds to the license has a standard picture quality, and “HD image quality” indicates that the content which corresponds to the license has a high-standard picture quality.

When the non-secure data is judged as usable in Step S416 (Yes in Step S416), the usability assessment unit 204b executes the above process starting at S408. Whereas, when the non-secure data is judged to be unusable in Step S416 (No in Step S416), the usability assessment unit 204b further judges whether or not the assessment data acquired in Step S400 is secure data, based on the secure identification data acquired in Step S400 (Step S418).

Here, upon judging that the assessment data acquired in Step S400 is not secure data (No in Step S418), the usability assessment unit 204b finishes processing without transmitting the content key 207b to the host 100b and when the assessment data acquired in Step S400 is judged to be secure data (Yes in Step S418), the usability assessment unit 204b further assesses whether or not the present date/time and the number of uses in the assessment data, which is secure data, satisfy the use conditions 207a (Step S420). Upon assessing that the present date/time and the number of uses satisfy the use conditions 207a (Yes in Step 420), the usability assessment unit 204b transmits the content key 207b to the host 100b (Step S422). Whereas, upon assessing that the present date/time and the number of uses in the secure data do not satisfy the use conditions 207a (No in Step S420), the usability assessment unit 204b finishes processing without transmitting the content key 207b to the host 100b.

In this way, in the present embodiment, when judging non-secure data to be usable or not, based on the user's subscribed services, and the non-secure data is judged to be usable, it is assessed whether the present date/time of the assessment data satisfy the use conditions, regardless of whether the assessment data from the host is secure data or non-secure data. Accordingly, in the present embodiment, for services in which the secure data is not needed as assessment data, i.e. when the user subscribes only to services which do not require the present date/time to be securely managed, the assessment of whether or not use of the content is permitted can be easily performed without having to use secure data.

Also, in the present embodiment, the non-secure data is judged to be usable or not based on the service mode of the content, and when the non-secure data is judged to be usable, it is assessed whether or not the present date/time of the assessment data satisfy the use conditions, regardless of whether the assessment data from the host is secure data or non-secure data. Accordingly, in the present embodiment, when the user tries to view content which does not require secure data to be assessment data, i.e. content in which the present date/time does not have to be securely managed by the host, whether or not use of the content is permitted can be easily assessed without having to use secure data for assessing whether or not use of the content is permitted.

Note that in the present embodiment, when the non-secure data is judged to be usable or not based on the service mode of the content, this judgment may be performed based on the type of use condition. For example, when a use permitted period is included in the use conditions, the non-secure data is judged to be unusable and when accumulated use time is included in the use conditions, non-secure data is judged to be usable.

Also, in the present embodiment, the process which accompanies Step S402 and the process which accompanies Step S414 are performed repeatedly, however only one of these processes need be performed. More specifically, in the present embodiment, the usability of non-secure data is judged based on subscribed services and the mode of the services, however the usability of non-secure data may also be judged based on either the service subscribed to or the service mode.

(Modification)

A modification of the use conditions 207a in the present embodiment is described.

The use conditions 207a, according to the present modification, indicate the presence or absence of a flag instead of the service mode as above. The presence or absence of a flag explicitly indicates whether non-secure data can be included in the assessment of whether or not use of the content is permitted. More specifically, flag “present” indicates that non-secure data is not usable for assessing whether or not use of the content is permitted, i.e. only secure data can be used. Whereas flag “absent” indicates that non-secure data is also usable for assessing whether or not use of the content is permitted.

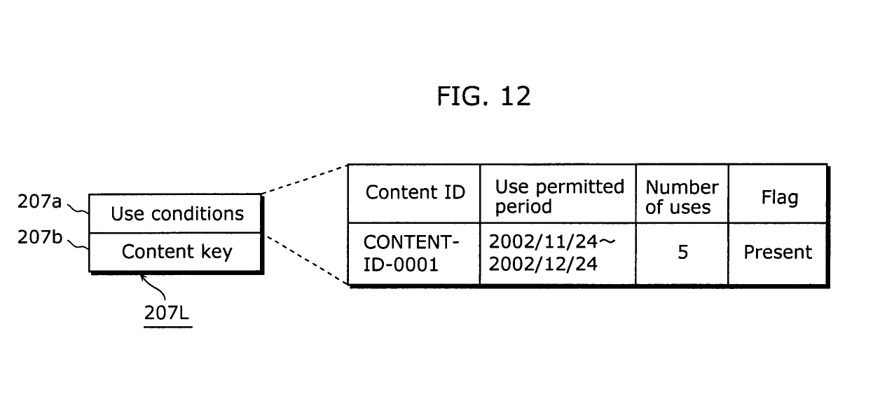

FIG. 12 is a diagram which shows use conditions 207a according to the present modification.

The use conditions 207a includes a content ID for content to be used, a use permitted period for the content, a number of uses for the content, and data which indicates the presence or absence of the flag above.

For instance, the use conditions 207a include a content ID “CONTENT-ID-0001”, a use permitted period “from Nov. 24, 2002 to Dec. 24, 2002”, “5 uses” for the number of uses and a flag “present”.

Subsequently, the usability assessment unit 204b according to the present modification judges whether or not non-secure data is usable for assessing whether or not use of the content is permitted based on the presence or absence of a flag instead of the service mode. For instance, when flag “present” is indicated in the use conditions 207a, the usability assessment unit 204b judges that the non-secure data is unusable. Likewise, when flag “absent” is indicated in the use conditions 207a, the usability assessment unit 204b judges that the non-secure data is usable.

In this way, since the possibility of an assessment of whether or not use of the content is permitted using non-secure data is shown explicitly in the presence or absence of a flag in the use conditions 207a of the license 207L, according to the present modification, the usability assessment unit 204b can easily and quickly judge whether or not the non-secure data is usable from the presence or absence of a flag.

Note that in the present embodiment and its modification, the subscription service management unit 206 includes the card 200b, but instead may also include the host 100b. In this case, the host 100b transmits the subscription service identification data 206b in the subscription service management unit 206 together with the content ID to the card 200b.

### Third Embodiment

The content use system in the present embodiment is a content use system that permits the use of the content under appropriate use conditions while maintaining a high security level, and includes a host and a card which is inserted into the host, as in the first embodiment or the second embodiment.

Here, the content use system in the present embodiment has the characteristic of selecting data which is used for assessing whether or not use of the content is permitted from secure data and non-secure data, according to the acquisition status of the server time data, which is secure data.

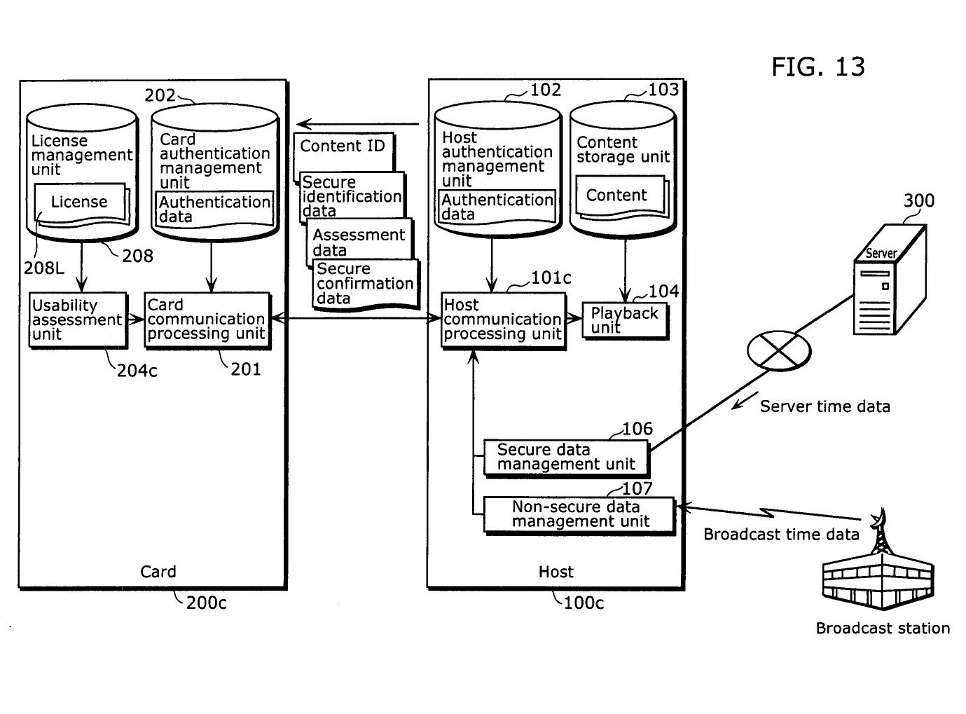

FIG. 13 is a block diagram which shows the internal configurations of a host and a card in the present embodiment.

A host 100c includes a host communication processing unit 101c, the host authentication management unit 102, the content storage unit 103, the playback unit 104, the secure data management unit 106 and the non-secure data management unit 107.

A card 200c includes the card communication processing unit 201, the card authentication management unit 202, the license management unit 208, and the usability assessment unit 204c. The card 200c is tamper proofed by its hardware.

Note that those elements among the constituent elements in the present embodiment above which are the same as the constituent elements in the first embodiment or the second embodiment are shown with the same numbering as the constituent elements in the first embodiment or the second embodiment, and a detailed explanation is not repeated.

Upon accepting a request for the content key from the playback unit 104, the host communication processing unit 101c transmits to the communication processing unit 201 a content ID for identifying the content, the assessment data which is managed by the secure data management unit 106 or the non-secure data management unit 107, secure identification data for identifying whether the assessment data is secure data or non-secure data, and secure confirmation data, which indicates whether or not server time data is acquired within a predetermined period from the server 300. For example, when the host communication processing unit 101c of the present embodiment records the acquired date/time that the secure data management unit 106 acquires from the server 300, and the acquired date/time is within the above predetermined period earlier than the present date/time, the host communication processing unit 101 transmits secure confirmation data which indicates that the server time data has been acquired within the predetermined period. Whereas, when the acquired date/time is not within the above predetermined period earlier than the present date/time, the host communication processing unit 101c transmits the secure confirmation data, which indicates that the server time data has not been acquired within the predetermined period. Note that the usability assessment unit 204c, and the like, in the card 200c may be made to manage (record) the data which indicates the above predetermined period, and a license 208L may be included in the license management unit 208. When data which indicates the above predetermined period is included in the license 208L, the above predetermined period can be modified per content. Also, the above predetermined period may be made modifiable from the transmitting side.

More specifically, among the functions of the host communication processing unit 101c in the present embodiment, the function for transmitting secure data or non-secure data, secure identification data and secure confirmation data with a content ID differs from the function of the host communication unit 101 in the first embodiment for transmitting secure data only; other functions are the same as the host communication device 101 in the first embodiment.

The license management unit 208 stores and manages plural licenses 208L for each content.

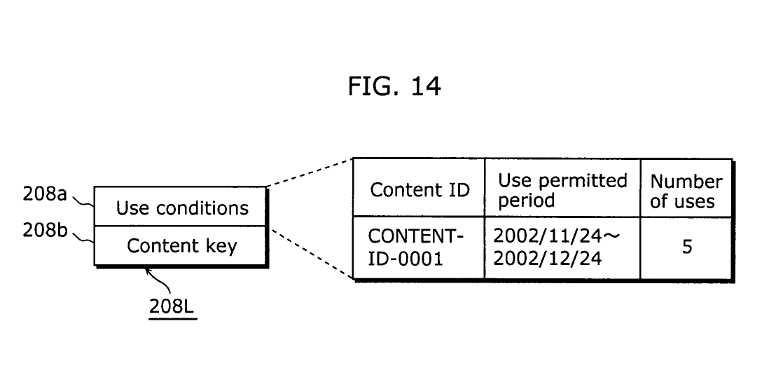

FIG. 14 is a diagram which shows data items included in the license which the license management unit 208 manages.

The license 208L includes use conditions 208a which indicate the conditions for whether or not use of the content is permitted, and a content key 208b required for decrypting content.

The use conditions 208a do not include the usability code of the first embodiment or the service mode of the second embodiment and so on, but include a content ID for the content to be used, a use permitted period and a number of uses for the content. For instance, the use conditions 208a include a content ID “CONTENT-ID-0001”, a use permitted period “from Nov. 24, 2002 to Dec. 24, 2002” and 5 uses.

Upon acquiring a content ID, assessment data and secure identification data from the host 100c through the card communication processing unit 201, the usability assessment unit 204c identifies the license 208L which corresponds to the content ID acquired from among the plural licenses 208L managed by the license management unit 208. Next, the usability assessment unit 204c assesses whether or not the content of the content ID is usable by the host 100c, based on the use conditions 208a included in the license 208L identified, assessment data, secure confirmation data and secure identification data acquired from the host 100c. Upon judging that use of the content is permitted, the usability assessment unit 204c transmits the content key 208b included in the license 208L to the communication processing unit 101c through the card communication processing unit 201.

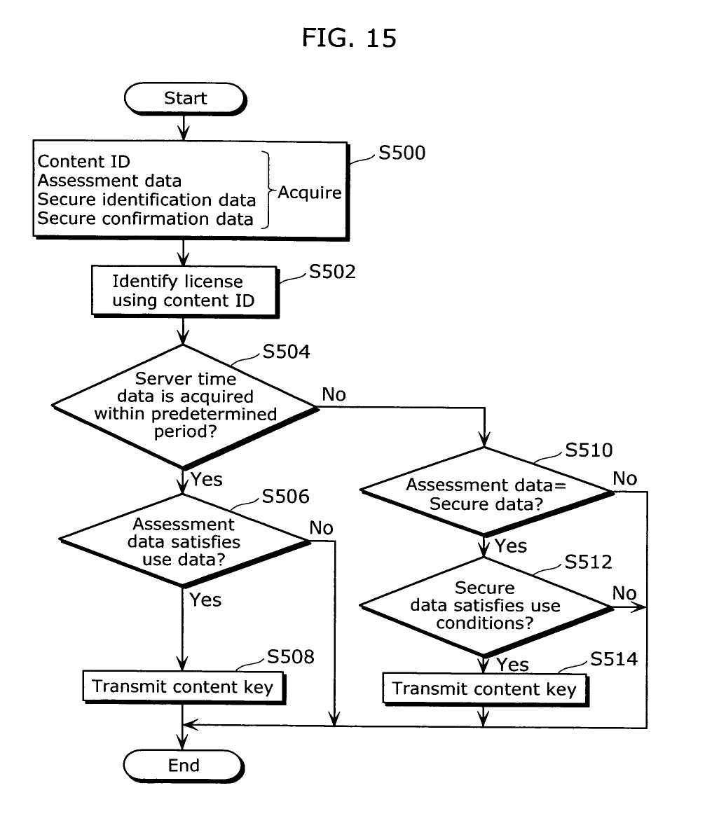

FIG. 15 is a flowchart which shows the operations of the usability assessment unit 204c in the card 200c in the present embodiment.

First, the usability assessment unit 204c acquires the content ID, the assessment data and the secure identification data from the host 100c through the card communication processing unit 201 (Step S500). Next, the usability assessment unit 204c identifies the license 208L according to the content ID acquired in Step S500 (Step S502).

Next, the usability assessment unit 204c judges whether or not the server time data has been acquired from the server 300 within the predetermined period, based on the secure confirmation data acquired in Step S500 (Step S504).

Upon judging that the server time data has been acquired within the predetermined period (Yes in Step S504), the usability assessment unit 204c further assesses whether or not the present date/time and the number of uses of the assessment data satisfies the use conditions 208a regardless of whether the assessment data acquired in Step S500 is secure data or not (Step S506). More specifically, when the server time data is acquired within the predetermined period, the present date/time of the secure data is amended accurately and as a result, the usability assessment unit 204c judges that the present date/time of the non-secure data may be considered as the present date/time of the secure data since the reliability of non-secure data is considered to be high.

Upon assessing that the present date/time and the number of uses in the assessment data satisfy the use conditions 208a in Step S506 (Yes in Step S506), the usability assessment unit 204c transmits the content key 208b to the host 100c (Step S508). Whereas, upon assessing that the present date/time and the number of uses in the assessment data do not satisfy the use conditions 208a (No in Step S506), the usability assessment unit 204c finishes processing without transmitting the content key 208b to the host 100c.

Also, upon judging that the server time data has not been acquired within the predetermined period in Step S504 (No in Step S504), the usability assessment unit 204c further judges whether or not the assessment data acquired in Step S500 is secure data based on the secure identification data acquired in Step S500 (Step S510).

Upon judging that the assessment data is not secure data (No in Step S510), the usability assessment unit 204c finishes processing without transmitting the content key 208b to the host 100c, and upon judging that the assessment data is secure data (Yes in Step S510), the usability assessment unit 204c assesses whether or not the present date/time and the number of uses in the secure data, i.e. the assessment data, satisfy the use conditions 208a (Step S512). Upon assessing whether or not the present date/time and number of uses in the secure data satisfy the use conditions 208a (Yes in Step S512), the usability assessment unit 204c transmits the content key 208b to the host 100c (Step S514). Whereas, upon assessing that the present date/time and the number of uses in the secure data do not satisfy the use conditions 208a (No in Step S512), the usability assessment unit 204c finishes processing without transmitting the content key 208b to the host 100c.

In this way, in the present embodiment, the non-secure data is judged to be usable or not based on whether server time data, i.e. secure data, has been acquired within the predetermined period. When the server time data is acquired, it is assessed whether or not the present date/time of the assessment data satisfy the use conditions, regardless of whether the assessment data from the host is secure data or non-secure data. More specifically, in the present embodiment, when the host performs operations to appropriately amend the present date/time of the secure data, the present date/time of the non-secure data is considered reliable. As a result, in the present embodiment, when the host performs operations to appropriately amend the present date/time of the secure data, secure data is not used in assessing whether or not use of the content is permitted and so the assessment can be easily performed.

Note that in the present embodiment, the secure confirmation data indicates whether or not the server time data is acquired from the server 300 within the predetermined period, however the secure confirmation data may also indicate the date/time acquired in the server time data. In this case, the usability assessment unit 204c in the card 200c, which acquired the secure confirmation data, judges whether or not the server time data is acquired within the predetermined period based on the date/time indicated in the secure confirmation data. More specifically, the usability assessment unit 204c in the card 200c stores the most recently acquired secure data from the host 100c (the server time data), and by comparing the date/time indicated by the server time data with the date/time indicated by the secure confirmation data, the usability assessment unit 204c judges whether or not the server time data has been acquired within the predetermined period. Here, when the host 100c communicates with the server 300 through the card 200c, the usability assessment unit 204c of the card 200c may directly acquire and store server time data from the server 300 during the communication, instead of, as above, storing the server time data most recently acquired from the host 100c above. Additionally, the card 200c may prompt the host 100c to transmit the secure confirmation data to the card 200c with timing corresponding to the predetermined period above, and also prompt the host 100c to acquire the secure data through communication.

### Fourth Embodiment

The content use system in the present embodiment is a content use system that permits the use of the content under appropriate use conditions while maintaining a high security level, and includes a host and a card inserted into the host, as in the first through third embodiments.

Here, for the content use system in the present embodiment, the card has particular characteristics though the host in the present embodiment is the same as the host 100b in the second embodiment. The card in the present embodiment has the characteristic that it permits content to be usable by the host under predetermined restrictions no matter the items in the non-secure data, even when the card has acquired non-secure data for assessment data.

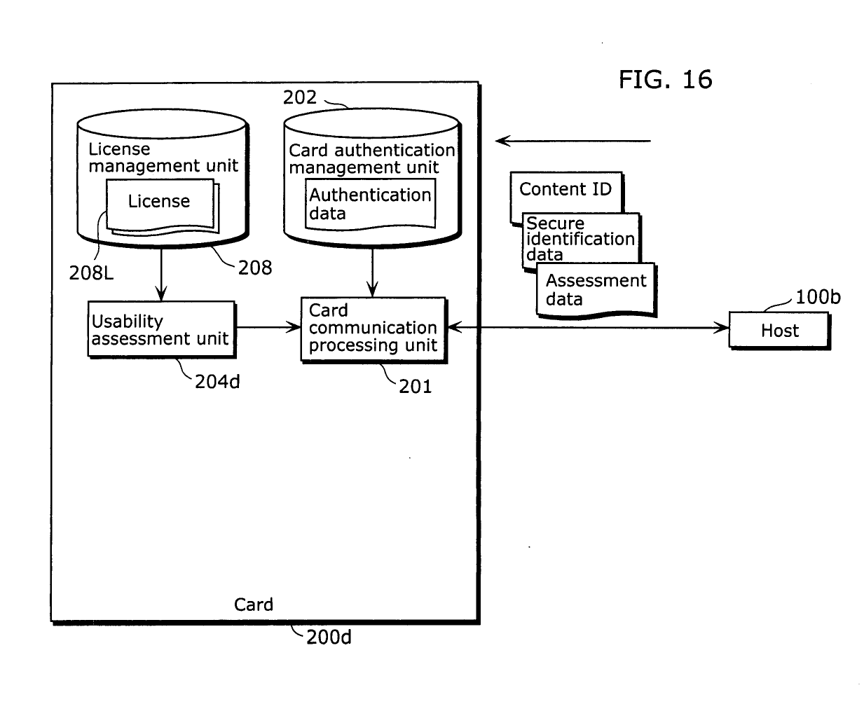

FIG. 16 is a block diagram which shows the internal configuration of the card in the present embodiment.

The card 200d includes the card communication processing unit 201, the card authentication management unit 202, the license management unit 208, and a usability assessment unit 204d. The card 200d is tamper proofed by its hardware.

Note that, among the constituent elements in the present embodiment above, those elements which are the same as the first through third embodiments are shown with the same numbering as the constituent elements in the first through third embodiments, and a detailed explanation is not repeated.

Upon acquiring a content ID, assessment data and secure identification data from the host 100b through the card communication processing unit 201, the usability assessment unit 204d identifies the license 208L, which corresponds to the content ID acquired, from among the plural licenses 208L managed by the license management unit 208. Next, the usability assessment unit 204d assesses whether or not use of the content of the content ID is permitted by the host 100b, based on the use conditions 208a included in the license 208L identified, assessment data acquired from the host 100b, and the secure identification data. Upon assessing that use of the content is permitted, the usability assessment unit 204d transmits the content key 208b included in the license 208L to the host communication processing unit 101b through the card communication processing unit 201. Here, even when the usability assessment unit 204d of the card 200d in the present embodiment acquires non-secure data for assessment data as above, the usability assessment unit 204d can permit content to be usable by a host under predetermined restrictions, by for example, restricting the number of playbacks or a playback time period regardless of the items in the non-secure data.

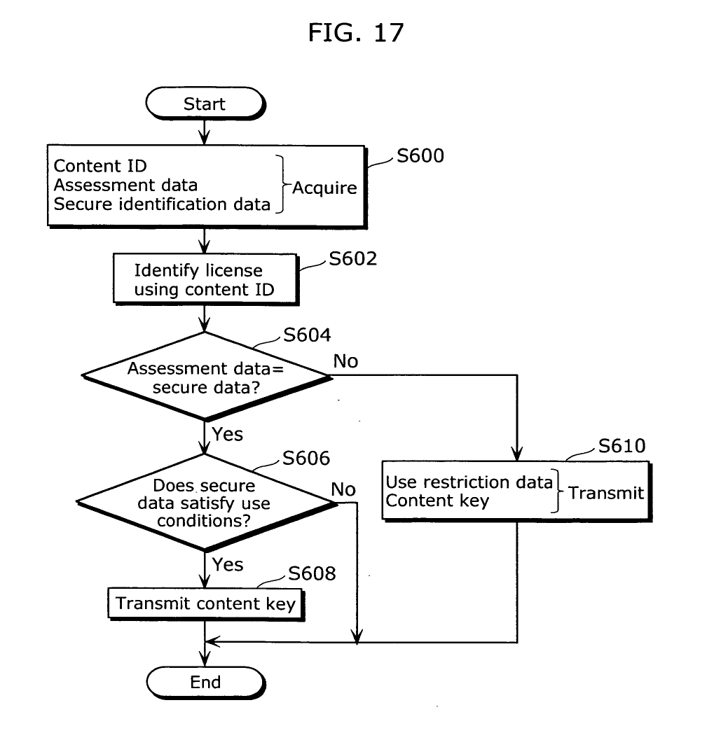

FIG. 17 is a flowchart which shows the operations of the usability assessment unit 204d in the card 200d in the present embodiment.

The usability assessment unit 204d acquires a content ID, assessment data and secure identification data from the host 100b through the card communication processing unit 201 (Step S600). Next, the usability assessment unit 204d identifies the license 208L corresponding to the content ID acquired in Step S600 (Step S602).

Subsequently, the usability assessment unit 204d judges whether or not the assessment data acquired in Step S600 is secure data based on the secure identification data acquired in Step S600 (Step S604).

Here, upon judging that the assessment data is secure data (Yes in Step S604), the usability assessment unit 204d assesses whether or not the present date/time and the number of uses in the secure data, i.e. the assessment data, satisfy the use conditions 208a (Step S606). Upon assessing in Step S606 that the present date/time and the number of uses in the secure data satisfy the use conditions 208a (Yes in Step S606), the usability assessment unit 204d transmits the content key 208b to the host 100b (Step S608). Also, when the usability assessment unit 204d assesses in Step S606 that the present date/time and the number of uses in the secure data do not satisfy the use conditions 208a (No in Step S606), the usability assessment unit 204d finishes processing without transmitting the content key 208b to the host 100b.

Meanwhile, upon judging in Step S604 that the assessment data is not secure data (No in Step S604), the usability assessment unit 204d transmits the use restriction data and the content key 208b to the host 100b (Step S610). This use restriction data indicates items which restrict the number of playbacks, the playback time period, a playback time and playback image quality. For example, the use restriction data indicates that there are up to three permitted playbacks, that the playback time period is up to 30 minutes in total, that the playback period lasts until Apr. 1, 2005, that the playback image quality is at a low level and so on.

The host 100b, which has acquired the use restriction data and the content key 208b, decrypts the content using the content key 208b and plays back the content within a range restricted by the use restriction data.

Thus, in the present embodiment, since the content is permitted to be used by the host under predetermined restrictions; user convenience can be enhanced even when the assessment data is not secure data.

Note that in the present embodiment, when the assessment data is not secure data, the usability assessment unit 204d transmits the content key 208b and the use restriction data; the usability assessment unit 204d may also transmit message data which prompts the transmission of secure data to the user. In this case, the host 100b, which acquires the message data, presents the items displayed in the message data to the user and prompts transmission of the secure data.

In the description above, the content use device in the present invention is described using embodiments and modifications, however, the present invention is not limited to these embodiments and modifications.

For example, in the first through third embodiments and the modifications, when the card assesses that use of the content is permitted, the card transmits only the content key to the host, and in the fourth embodiment, the card may transfer rendering conditions (corresponding to use restriction data in the fourth embodiment) related to the rendering of the content such as, for instance, content playback time, content quality at playback time and so on together with the content key. In this case, the host in the first through third embodiments and the modifications plays back content according to the rendering conditions. For example, when the rendering condition is “playback time period 30 minutes”, the content is played back within 30 minutes only after the host decrypts the content with the content key. Note that the rendering conditions above are included in the license, and the use restriction data above may also be included in the license, and may be stored ahead of time in the card regardless of the license.

Also, in the first embodiment and its modifications, the host 100 sends both the present date/time and the region code to the card 200 and the card 200a as secure data, however, the host 100 may transmit the present date/time or the region code to the card 200 and the card 200a.

Also, in the first through fourth embodiments and the modifications, the host transmits the content ID to the card and may transmit other data which can identify the license, for example, the host may transmit the license ID.

Also, in the content use system in the first through fourth embodiments and the modifications, the host transmits secure data or non-secure data every time the host queries the card about whether or not use of the content is permitted, instead the host may transmit secure data or non-secure data only after an SAC is established. In this case, the host transmits the secure data or the non-secure data when the SAC is established, and afterwards, when querying about whether or not use of the content is permitted, the host transmits the content ID only. Subsequently, every time the card receives a query, about whether or not use of the content is permitted, from the host, the card assesses whether or not use of the content is permitted based on secure data or non-secure data acquired while the SAC is established. Also, the host may transmit secure data or non-secure data when initializing the card. In this case, for example, when the card is inserted into the host, the host performs initialization for the card and afterwards transmits the secure data or the non-secure data. Subsequently, for example, when the card is removed from the host, or when the power supply to the card or the host is stopped and a predetermined time period has elapsed after the secure data or the non-secure data has been transmitted to the card, or when the SAC is closed, the host deletes the secure data which is held in the card.

Also, in the first through fourth embodiments and the modifications, the host authentication management unit 102 and the card authentication management unit 202 may acquire the most recent revocation list from the server 300 or another server respectively (below, abbreviated simply as server). In this case, for example, the host authentication management unit 102 acquires the revocation list from the server through the host communication processing unit 101, and the card authentication management unit 202 acquires the revocation list from the server through the card communication processing unit 201. Here, since the card communication processing unit 201 cannot be connected directly with the server, the card authentication management unit 202 acquires the revocation list through a terminal device which can be connected to the server as well as the card communication processing unit 201. More specifically, the card authentication management unit 202 acquires the revocation list when the card 200 or card 200a is inserted into the terminal device. Also, the card authentication management unit 202 may acquire the revocation list from the host authentication management unit 102 in the same way as the host authentication management unit 102 does above, and the host authentication management unit 102 may acquire the revocation list from the card authentication management unit 202 in the same way as the card authentication management unit 202 does above. Note that when the host authentication management unit 102 or the card authentication management unit 202 acquire the revocation list from the server, in order to prevent tampering and re-forwarding attacks on the revocation list, the host communication processing unit 101 or the card communication processing unit 201 perform communication through an SAC with the server.

Also, in the first embodiment and its modification, the secure data management unit 105 of the host 100 manages the secure data; however the secure data management unit 105 may also acquire the secure data managed by the server. In this case, the secure data management unit 105 acquires the present date/time as secure data from the server through the host communication processing unit 101 and transmits the present date/time to the card 200 or the card 200a. Also, for the first modification in the first embodiment, the most recent present date/time notified from the server and through the host 100 is managed by the card secure data management unit 205 as the most recent date/time. For instance, the secure data management unit 105 of the host 100 acquires the secure data from the server and transmits the secure data to the card 200 or card 200a when the revocation list or the license 203L are transmitted from the server to the card 200, the card 200a or the host 100.

Also, in the second modification of the first embodiment, when the region code and the card region code for the card 200a do not match, the host 100 regards use of the content as not permitted and does not transmit the content key 203b, however even when the region code and the card region code do not match for the card 200a, the content key 203b may still be transmitted. In this case, when the region code or the card region code match the usability code in the use conditions 203a, and when the present date/time and number of uses for the secure data satisfy the use conditions 203a, the card 200a assesses use of the content to be permitted by the host 100 and transmits the content key 203b.

### INDUSTRIAL APPLICABILITY

The content use system in the present invention has the effect of permitting use of content under appropriate use conditions while maintaining a high security level, and can be applied, for instance, to a content playback system and the like which play back distributed video and other content through the Internet.

1-31. (canceled)

32. A content use system which includes a card and a host terminal and uses digitally authored content by mutual communication between said card and said host terminal,
wherein said host terminal includes:
a secure data management unit operable to securely manage secure data, which is used for assessing whether or not use of the content is permitted and indicates at least one of a date/time and a region, in a tamper proofed state;
a data transmission unit operable to transmit the secure data managed by said secure data management unit to said card;
a use unit operable to use the content in the case where use of the content has been assessed to be permitted by said card, and
said card including:
a condition holding unit operable to hold a use condition for the content;
a data acquisition unit operable to acquire the secure data from said host terminal, and
an assessment unit operable to assess whether or not use of the content is permitted in said host terminal based on the secure data acquired by said data acquisition unit and the use condition held in said condition holding unit.

33. The content use system according to claim 32,
wherein said card further includes:
a key holding unit operable to hold a content key for decrypting the encrypted content;
said assessment unit is operable to transmit the content key held in said key holding unit to said host terminal upon assessing that use of the content is permitted, and
said use unit is operable to acquire the content key transmitted from said assessment unit, and to decrypt the encrypted content using the acquired content key and play back the content.

34. The content use system according to claim 33,
wherein said secure data management unit is operable to manage a present date/time obtained by time measurement, as the secure data,
said condition holding unit is operable to hold a use condition which indicates a use permitted period, and
said assessment unit is operable to assess that use of the content is permitted when the date/time indicated by the secure data are within the use permitted period, which is a use condition, and to assess that use of the content is not permitted when the date/time indicated by the secure data is not within the use permitted period of the content.

35. The content use system according to claim 34,
wherein said card further includes a date/time holding unit operable to securely hold a date/time, which is indicated by the secure data most recently acquired by said data acquisition unit, in a tamper proofed state, and
said assessment unit is operable to assess that use of the content is not permitted in said host terminal when a date/time indicated by the secure data acquired by said data acquisition unit is earlier than the date/time held by said date/time holding unit.

36. The content use system according to claim 33,
wherein said secure data management unit is operable to manage a usage region in which the content is used, as the secure data,
said condition holding unit is operable to hold the use condition which indicates permitted regions for the content, and
said assessment unit is operable to assess that use of the content is permitted when the usage region indicated by the secure data is among the permitted regions for the content, which is a use condition, and to assess that use of the content is not permitted when the usage region indicated in the secure data is not among the permitted regions.

37. The content use system according to claim 36,
wherein said card further includes a region holding unit operable to securely hold region data which indicates a predetermined region in a tamper proofed state, and
said assessment unit is operable to assess that use of the content is not permitted in said host terminal when the usage region indicated by the secure data acquired by said data acquisition unit does not match a region indicated by the region data.

38. The content use system according to claim 33,
wherein said data transmission unit is operable to transmit the secure data to said card every time assessment is performed by said assessment unit, and
said assessment unit is operable to perform assessment using the secure data most recently acquired by said data acquisition unit.

39. The content use system according to claim 33,
wherein said data transmission unit is operable to transmit the secure data to said card when a secure communication channel is established between said card and said host terminal, and
said assessment unit is operable to perform assessment using secure data acquired by said data acquisition unit after the secure communication channel is established.

40. The content use system according to claim 33,
wherein said host terminal further includes
an initialization unit operable to perform initialization for said card; and
said data transmission unit is operable to transmit the secure data when said card is initialized by said initialization unit, and
said assessment unit is operable to perform assessment using secure data acquired by said data acquisition unit when initialized.

41. The content use system according to claim 33,
wherein said card further includes
a secure data holding unit operable to securely hold card secure data, which is used for assessing whether or not use of the content is permitted and indicates at least one of a date/time and a region, in a tamper proofed state, and
said assessment unit is operable to assess whether or not use of the content is permitted based on the secure data, the card secure data and the use condition.

42. The content use system according to claim 33,
wherein said card further includes
a card-side authentication unit operable to authenticate said host terminal, and
said host terminal further includes
a host-side authentication unit operable to authenticate said card, and
said card-side authentication unit and said host authentication unit are operable respectively to: hold a list that indicates devices to be excluded as unauthorized communication peers, to prohibit communication with devices indicated on the list; and to register a peer in the list upon judging that the peer is an unauthorized device, as a result of said authentication.

43. A card which communicates with a host terminal that uses digitally-authored content, said card comprising:
a condition holding unit operable to hold a use condition for the content;
a data acquisition unit operable to acquire secure data from the host terminal managed securely in a tamper proofed state, the secure data being used for assessing whether or not use of the content is permitted and which indicates at least one of a date/time and a region;
an assessment unit operable to assess whether or not use of the content is permitted in the host terminal based on the secure data acquired by said data acquisition unit and the use condition held in said condition holding unit, and
a use unit operable to permit use of the content for the host terminal in the case where use of the content has been assessed to be permitted by said assessment unit.

44. The card according to claim 43, further comprising:
a key holding unit operable to hold a content key for decrypting the encrypted content, and
said use unit is operable to transmit the content key, held by said key holding unit, to the host terminal in the case where use of the content has been assessed to be permitted by said assessment unit.

45. The card according to claim 44,
wherein said data acquisition unit is operable to acquire the secure data which indicates a present date/time,
said condition holding unit is operable to hold the use condition which indicates a use permitted period of the content, and
said assessment unit is operable to assess use of the content to be permitted when the present date/time indicated by the secure data is within the use permitted period of the content, which is the use condition, and to assess that use of the content is not permitted when the present date/time indicated by the secure data is not within the use permitted period of the content.

46. The card according to claim 44,
wherein said data acquisition unit is operable to acquire the secure data which indicates a usage region in which the content is used,
said condition holding unit is operable to hold the use condition which indicates a use permitted region of the content, and
said assessment unit is operable to assess that use of the content is permitted when the usage region indicated by the secure data is within the use permitted region of the content, which is the use condition, and to assess that use of the content is not permitted when the usage region indicated by the secure data is not within the use permitted region of the content.

47. The card according to claim 44,
wherein said data acquisition unit is operable to acquire one of non-secure data, which indicates at least the date/time, and the secure data which are used for assessing whether or not use of the content is permitted, as assessment data, the non-secure data being managed in the host terminal in such a way as to be modifiable by the user, from the host terminal,
said card further comprises:
an identification acquisition unit operable to acquire secure identification data, which indicates whether the assessment data is the secure data or the non-secure data, from the host terminal;
a secure distinguishing unit operable to distinguish whether assessment data most recently acquired by said data acquisition unit is secure data or non-secure data, based on the secure identification data; and
a non-secure usability distinguishing unit operable to distinguish whether or not the non-secure data is usable for assessing whether or not use of the content is permitted, and
when the non-secure data is distinguished to be usable by said non-secure usability distinguishing unit, said assessment unit is operable to assess whether or not use of the content is permitted in the host terminal based on the assessment data which is one of the non-secure data and the secure data, and the use condition, and
when the non-secure data is distinguished to be unusable by said non-secure usability distinguishing unit the assessment information is distinguished to be the secure data by said secure distinguishing unit, said assessment unit is operable to assess whether or not use of the content is permitted in the host terminal based on the assessment data, which has been distinguished to be the secure data, and the use condition.

48. The card according to claim 47,
wherein said condition holding unit is operable to hold provision-mode data in association with the use condition, the provision-mode data indicating a mode of providing the content, and
said non-secure usability distinguishing unit is operable to identify a mode-provision for the content based on the provision-mode data held in said condition holding unit, and to distinguish whether or not the non-secure data is usable according to the provided mode that is identified.

49. The card according to claim 47, further comprising:
a service storage unit operable to store service identification data for identifying a service to which the user subscribes, and
said non-secure usability distinguishing unit is operable to distinguish whether or not the non-secure data is usable, based on the service identification data stored in said service storage unit.

50. The card according to claim 47,
wherein said non-secure usability distinguishing unit is operable to distinguish whether or not the non-secure data is usable based on a management status of the secure data in the host terminal.

51. The card according to claim 44,
wherein said data acquisition unit is operable to acquire the non-secure data, which indicates at least the date/time, and the secure data from the host terminal as assessment data respectively, at different respective times, both of the secure data and the non-secure data being used for assessing whether or not use of the content is permitted, the non-secure data being managed in the host terminal in such a way as to be modifiable by the user, and
said card further comprises:
an identification acquisition unit operable to acquire secure identification data, which indicates whether the assessment data is the secure data or the non-secure data, from the host terminal;
a secure distinguishing unit operable to distinguish whether the assessment data most recently acquired by said data acquisition unit is the secure data or the non-secure data based on the secure distinguishing data; and
a non-secure usability distinguishing unit operable to distinguish whether or not the non-secure data is usable for assessing whether or not use of the content is permitted, and
when the non-secure data is distinguished to be usable by said non-secure usability distinguishing unit, said assessment unit is operable to assess whether or not use of the content is permitted in the host terminal based on the assessment data most recently acquired by said data acquisition unit, and the use condition, and
when the non-secure data is distinguished to be unusable by said non-secure usability unit and the assessment data is distinguished to be the secure data by said secure distinguishing unit, said assessment unit is operable to assess whether or not use of the content is permitted in the host terminal based on the assessment data, which is distinguished to be the secure data, and the use condition.

52. A content use terminal which uses digitally-authored content by communicating with a card, said content use terminal comprising:
a secure data management unit operable to securely manage secure data, which indicates at least one of a date/time and a region, used for assessing whether or not use of the content is permitted, in a tamper-proofed state;
a data transmission unit operable to transmit secure data, managed by said secure data management unit, to the card, and
a use unit operable to use the content in the case where use of the content is assessed to be permitted by the card based on the secure data.

53. The content use terminal according to claim 52,
wherein the card transmits a content key for decrypting the encrypted content to said content use terminal, in the case where the card has assessed use of the content to be permitted, and
said use unit is operable to acquire the content key transmitted from the card, to decrypt the encrypted content using the content key acquired and to play back the content.

54. The content use terminal according to claim 53,
wherein said secure data management unit is operable to manage a present date/time, obtained by time measurement, as the secure data, and
said data transmission unit is operable to transmit secure data which indicates the present date/time to the card.

55. The content use terminal according to claim 53,
wherein said secure data management unit is operable to manage a usage region, in which the content is used, as the secure data, and
said data transmission unit is operable to transmit, to the card, secure data which indicates the usage region.

56. The content use terminal according to claim 53, further comprising:
a secure data management unit operable to non-securely manage non-secure data, which indicates at least the date/time and which is used for assessing whether or not use of the content is permitted, the non-secure data being managed in the host terminal in such a way as to be modifiable by the user,
said data transmission unit is operable to transmit the non-secure data managed by said non-secure data management unit to the card, instead of the secure data, and
said use unit is further operable to use the content in the case where use of the content is assessed to be permitted by the card based on the non-secure data.

57. The content use terminal according to claim 56, further comprising:
an identification data transmission unit operable to transmit secure identification data to the card, the secure identification data indicating whether one of secure data and non-secure data has been transmitted by said data transmission unit.

58. A content use method in which digitally authored content is used by mutual communication between a card and a host, said content use method comprising:
a data transmission step in which the host terminal transmits secure data to the card, the secure data being managed by the host terminal in a tamper proofed state and indicating at least one of a date/time and a region;
a data acquisition step in which the card acquires secure data from the host terminal;
an assessment step in which the card assesses whether or not use of the content is permitted in the host terminal based on the secure data, which is acquired in said data acquisition step, and a use condition of the content; and
a use step in which the host terminal uses the content in the case where use of the content has been assessed to be permitted in said assessment step.

59. A content use control method in which a card, which communicates with a host terminal that uses digitally-authored content, controls use of the content in the host terminal, said content control method comprising:
a data acquisition step of acquiring secure data from the host terminal which manages the secure data in a tamper proofed state, the secure data being used for assessing whether or not use of the content is permitted and indicating at least one of a date/time and a region;
an assessment step of assessing whether or not use of the content is permitted in the host terminal based on the secure data acquired in said data acquisition step and a use condition for the content, and
a use step of permitting the use of the content for said host terminal in the case where use of the content has been assessed to be permitted in said assessment step.

60. A content use method in which a host terminal uses digitally authored content by communicating with a card, said content use method comprising:
a data transmission step of transmitting secure data to the card, the secure data being managed by the host terminal in a tamper proofed state and indicating at least one of a date/time and a region, and
a use step of using the content in the case where use of the content has been assessed to be permitted, based on the secure data.

61. A program in which a card, which communicates with a host terminal that uses digitally authored content, controls use of the content in the host terminal, said program causing a computer to execute:
a data acquisition step of acquiring secure data from said host terminal which manages the secure data in a tamper proofed state, the secure data being used for assessing whether or not use of the content is permitted and indicating at least one of a date/time and a region;
an assessment step of assessing whether or not use of the content is permitted in the host terminal, based on the secure data acquired in said data acquisition step and a use condition for the content; and
a use step of permitting use of the content for said host terminal in the case where use of the content has been assessed to be permitted in said assessment step.

62. A program for using digitally-authored content by a host terminal communicating with a card, said program causing a computer to execute:
a data transmission step of transmitting secure data to the card, the secure data being managed in a tamper proofed state by the host terminal and indicating at least one of a date/time and a region; and
a use step of using the content in the case where use of the content has been assessed to be permitted by the card, based on the secure data.
